(19) United States
(12) Patent Application Publication
(10) Pub. No.: US 2016/0332860 A1
(43) Pub. Date: Nov. 17, 2016

(54) BEVERAGE DISPENSING DEVICE

(71) Applicant: Robert Cross, Pawcatuck, CT (US)

(72) Inventor: Robert Cross, Pawcatuck, CT (US)

(21) Appl. No.: 15/152,524

(22) Filed: May 11, 2016

Related U.S. Application Data
(60) Provisional application No. 62/160,154, filed on May 12, 2015.

(51) Int. Cl. B67D 1/08; B67D 1/16; B67D 1/12

(52) U.S. Cl. CPC B67D 1/0872; B67D 1/1277; B67D 1/16

(57) ABSTRACT

A beverage dispensing device that includes: a facial image, where the facial image includes an open mouth; a caldron below the facial image and the open mouth; a fluid opening in the open mouth, where the fluid opening directs fluid in a downward direction; and at least one motion sensor on the facial image, where the at least one motion sensor initiates a flow of fluid from the fluid opening upon detection of motion. Preferably, the facial image is a witch.

### CROSS REFERENCE TO OTHER APPLICATIONS

This application claims priority to U.S. Provisional Application Ser. No. 62/160,154 filed on May 12, 2015.

### BACKGROUND OF THE INVENTION

1. Field of Invention

The field of invention relates to a beverage dispensing device and includes a novel theme.

2. Description of Related Art

Large gatherings, events, and parties normally include serving beverages and food. The dispensing of beverages may be handled through the use of a self-serve system or through the use of a bartender. In terms of self-service fountain drinks are typically provided and pre-bottled beverages also may be available. One traditional means of dispensing beverages at parties and events include the use of punch bowls. A typical punch bowl includes a large bowl and a serving ladle that is used to dip into the bowl and therefore transfer the liquid into a cup. As stated various other options are available for beverage dispensing in terms of fountain systems for carbonated drinks and simple containers that include a spigot that allows an individual to release the fluids or liquids into a cup. Many times these events or parties may be structured around a particular holiday or other types of themed festivals. As a result it would be advantageous to have a theme-designed beverage dispensing system that is suitable for holidays and theme related parties.

### SUMMARY OF THE INVENTION

The present invention relates to a beverage dispensing device that includes: a facial image, where the facial image includes an open mouth; a caldron below the facial image and the open mouth; a fluid opening in the open mouth, where the fluid opening directs fluid in a downward direction; and at least one motion sensor on the facial image, where the at least one motion sensor initiates a flow of fluid from the fluid opening upon detection of motion. Preferably, the facial image is a witch.

### BRIEF DESCRIPTION OF DRAWINGS

FIG. 1 depicts a beverage-dispensing device in accordance with the present invention.

### DETAILED DESCRIPTION

The present invention relates to a beverage-dispensing device that includes a cauldron, which receives overspill from liquid emitted through an image of a witch. The witch image is above the cauldron and the liquid is dispensed through the mouth of the witch through the use of sensors. The sensors may be placed near the mouth of the witch. In one particular embodiment, sensors are placed at the nose of the witch, which is tilted in a downward position and the release of the liquids are emitted through the witch's mouth. Therefore the image of the witch over the cauldron creates a puking image as a Halloween novelty. In alternative embodiment, the witch image may be removable to enable the insertion of other images such as a leprechaun for St. Patrick Day, a clown for a birthday or other image directed toward a particular theme.

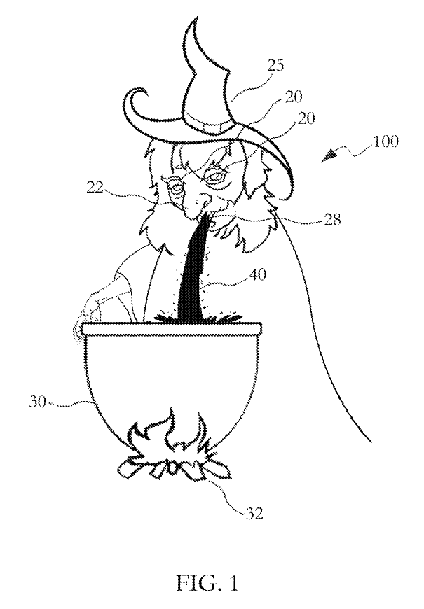

In reference to FIG. 1, the beverage-dispensing device 100 in accordance with the present invention is depicted. The beverage-dispensing device includes a witch image, which traditionally includes a disfigured female face with a pointed hat as shown in FIG. 1. The face is directed downward toward a cauldron 30 that includes a base 32. The base 32 preferably includes a mock image of a wood fire. Above the cauldron 30, a witch image 25 shows the face of a witch directed toward the cauldron 30 with an open mouth that allows for the emission of beverages. A fluid opening 28 is within the open mouth of the witch image 25. Sensors 22 may be embedded in the nose of the witch's image. The sensors 22 detect motion and therefore initiate the emission of beverages through the fluid opening 28. Fluid 40 is transferred through the fluid opening 28 and a user may simply place a cup or a container under the flow of fluid 40. Any excess liquids are then captured in the cauldron 30 below the witch image 25. In one particular embodiment, eyes 20 of the witch image 25 may include illumination capabilities, so that the eyes 20 illuminate along with the emission of fluid 40 through the fluid opening 28.

In alternative embodiments the witch image 25 is removable and may be replaced with another image. The alternative image preferably is associated with a theme related to the function or event where the beverage-dispensing device 100 is being used. Such exemplary images may include a leprechaun for St. Patricks Day, Santa Claus for Christmas or a clown for a birthday.

The present invention essentially creates an image of a puking witch over a cauldron that functions as a beverage-dispensing device. The beverage-dispensing device may be battery operated in one particular embodiment and therefore easily transported to various locations. The image creates a suitable novelty item for a Halloween season at various events and parties. The instant invention has been shown and described in what it considers to be the most practical and preferred embodiments. It is recognized, however, that departures may be made there from within the scope of the invention and that obvious modifications will occur to a person skilled in the art.

What is claimed is:

1. A beverage dispensing device comprising:
a. a facial image, where the facial image includes an open mouth;
b. a caldron below the facial image and the open mouth;
c. a fluid opening in the open mouth, where the fluid opening directs fluid in a downward direction; and
d. at least one motion sensor on the facial image, where the at least one motion sensor initiates a flow of fluid from the fluid opening upon detection of motion.

2. The beverage dispensing device where the facial image is a witch.

3. A method of beverage dispensing comprising the steps of:
a. integrating a fluid opening into a facial image;
b. directing fluid out of the fluid opening;
c. integrating at least one motion sensor into the facial image; and
d. positioning a caldron below the facial image and fluid opening, where said caldron is adapted to receive the fluid from the fluid opening.

4. The method of beverage dispensing according to claim 3, where fluid opening is aligned with a mouth of the facial image.
